(19) United States
(12) Patent Application Publication
(10) Pub. No.: US 2016/0373260 A1
(43) Pub. Date: Dec. 22, 2016

(54) Public Key Based Network

(71) Applicant: TELEFONAKTIEBOLAGET LM ERICSSON (PUBL), Stockholm (SE)

(72) Inventor: Christoffer Jerkeby, Malmö (SE)

(21) Appl. No.: 14/432,976

(22) PCT Filed: Feb. 26, 2015
(86) PCT No.: PCT/EP2015/054024

§ 371 Date: Apr. 1, 2015

(51) Int. Cl. H04L 9/32; H04L 9/30; H04L 9/00; H04L 9/14

(52) U.S. Cl. CPC H04L 9/3247; H04L 9/14; H04L 9/30; H04L 9/006; H04L 9/3263; H04L 9/3271

(57) ABSTRACT

There is provided a mechanisms for associating a node device with a network domain. The method is performed by a node manager. A method comprises acquiring an identity of a node device, wherein the identity is indicative of a public key of the node device. A method comprises at least temporarily storing the public key of the node device. A method comprises broadcasting a nonce challenge and a public key of the node manager. A method comprises receiving, from the node device, the nonce challenge and the public key of the node manager, both of which being signed by a private key of the node device.

### TECHNICAL FIELD

Embodiments presented herein relate to public key based networks, and particularly to methods, a node manager, a node device, computer programs, and a computer program product for associating a node device with a network domain.

### BACKGROUND

In general terms, communications networks, are built with a topology. The topology is the arrangement of the various elements (links, nodes, devices, etc.) of the communications network. The topology may be representative of the physical appearance and/or logical functionality of the communications network. Physical topology is the placement of the various components of the communications network, for example relating to device location and cable installations, whilst logical topology represents data flows within the communications network, regardless of its physical design. Hence, distances between nodes, physical interconnections, transmission rates, or signal types may differ between two communications networks, yet their topologies may be identical and one topology may be distributed over multiple nodes.

Network authentication and authorization mechanisms are traditionally centralized. A distributed network topology is most resilient when all its functions are distributed. For that reason it may be useful to have an authentication and authorization mechanism that is distributed on all (or many) nodes in communications network.

There are many known attacks on a communications network (regardless if the communications network is distributed or not). Some commonly known types of attacks are listed below. However, as the skilled person understands, these are just a few examples of attacks that can occur in a communications network. An attacker may forge the identity of another node. An attacker may change information before it reaches its destination. An attacker could eavesdrop on the communication of other nodes. An attacker may re-transmit encrypted or unknown communication to a node to cause a certain behavior to repeat on the destination node.

A network attack based on passively eavesdropping can be prevented using a cryptographic-channel between the two communicating nodes.

Public-key cryptography, also known as asymmetric cryptography, is a class of cryptographic algorithms which requires each node to have two separate keys, one of which is secret (or private), denoted a private key, and one of which is public, denoted a public key. To be able to distribute (or relay) encrypted messages to the correct destination node and to be able to verify the authenticity of the message during transit when public keys are used, it is vital that all nodes (that are relaying the encrypted messages) has knowledge of the public key of the transmitting node(s).

In general terms, a mesh network is a network topology in which each node relays data for the network. All nodes cooperate in the distribution of data in the network. The nodes in a mesh network are called mesh nodes. Each node in a given mesh network may thus need to gain knowledge of the public keys of all other nodes in the given mesh network. Traditionally this is achieved using a Public Key Infrastructure. In general terms, a public key infrastructure (PKI) may be provided by a set of hardware, software, policies, and/or procedures needed to create, manage, distribute, use, store, and revoke digital certificates. PKI is traditionally based on a centralized node certifying the authenticity of the certificates of all other nodes. Certification is implemented by using a root-certificate to cryptographically sign the public keys of the nodes. Existing PKI based schemes are centralized and for this reason less resilient to network attacks and disconnection from other networks.

Another possibility is to use Symmetric Cryptography which means that all nodes share a common secret to encrypt and decrypt all messages in the network. In general terms, symmetric-key algorithms, as used in symmetric 3o cryptography, are algorithms for cryptography that use the same cryptographic keys for both encryption of plaintext and decryption of ciphertext. The keys may be identical or there may be a simple transformation to go between the two keys. The keys, in practice, represent a shared secret between two or more nodes that can be used to maintain a private information link.

The re-transmit attack mentioned above is traditionally mitigated using cryptographic nonces, client nonces (cnonce). In general terms, a nonce may be regarded as a random numeric identity only used once in a cryptographic session to be used to identify what message is being responded to when transmitting a query and a response over a cryptographic channel. By using the nonce it is generally practically impossible for an attacker to “replay” the same data packet again to reproduce the same results.

Another concept used in node-to-node communication is to share a common secret. While this concept is applicable in a small scale it does not scale well with size and is thus not practical for a high amount of nodes (where data-leakage is more likely). If one node leaks the shared secret to an attacker, all nodes privacy is compromised. The shared secret approach lacks authenticated identity management; this means that the nodes are not securely identified individually.

A Distributed Hash Table (DHT) is a shared database stored redundantly on many nodes in a distributed network. Each entry may be stored as a pair comprising a key and a value. The nodes may use a command FindNode to requests a list of node identities in the DHT. The nodes may use a command Ping to verify node availability. The nodes may use a command AnnouncePeer to write and share an entry to the DHT. The nodes may use a command GetPeers to read data from other nodes in the DHT. Each node stores a routing table containing node identifiers of neighboring nodes. If a node receives a FindNode request for a node that is not in any its local DHT it may reply with the entire local DHT. This is done to allow the querying node 3o to extend its search in the network.

One approach using a Distributed Hash Tables is P2P SIP, see for example the paper entitled “Data format and interface to an external peer-to-peer network for SIP location service draft-singh-p2p-sip-oo” as presented at http://kundansingh.com/papers/draft-singh-p2p-sip-oo.txt (link verified on Feb. 10, 2015). This paper addresses the session initiation protocol (SIP) and key storage in DHT without a Certificate Authority.

Hence, there is still a need for an improved public key based network.

### SUMMARY

An object of embodiments herein is to provide an efficient public key based network.

According to a first aspect there is presented a method for associating a node device with a network domain. The method is performed by a node manager. The method comprises acquiring an identity of a node device, wherein the identity is indicative of a public key of the node device. The method comprises at least temporarily storing the public key of the node device. The method comprises broadcasting a nonce challenge and a public key of the node manager. The method comprises receiving, from the node device, the nonce challenge and the public key of the node manager, both of which being signed by a private key of the node device.

Advantageously this provides an efficient public key based network.

Advantageously provides a secure and distributed mechanism for associating node devices with a network domain.

Compared to PKI the proposed public key infrastructure mechanism has a higher availability if a network disturbance or attack occurs. Compared to a common shared secret approach the proposed public key infrastructure mechanism offers individual end to end privacy instead of a shared privacy.

According to a second aspect there is presented a node manager for associating a node device with a network domain. The node manager comprises a processing unit. The processing unit is configured to cause the node manager to acquire an identity of a node device, wherein the identity is indicative of a public key of the node device. The processing unit is configured to cause the node manager to at least temporarily store the public key of the node device. The processing unit is configured to cause the node manager to broadcast a nonce challenge and a public key of the node manager. The processing unit is configured to cause the node manager to receive, from the node device, the nonce challenge and the public key of the node manager, both of which being signed by a private key of the node device.

According to a third aspect there is presented a computer program for associating a node device with a network domain, the computer program comprising computer program code which, when run on a processing unit of a node manager, causes the node manager to perform a method according to the first aspect.

According to a fourth aspect there is presented a method for associating a node device with a network domain. The method is performed by the node device. The method comprises receiving a nonce challenge and a public key of a node manager being broadcasted by the node manager. The method comprises signing the nonce challenge and the public key of the node manager using a private key of the node device. The method comprises sending, to the node manager, the signed nonce challenge and public key of the node manager.

According to a fifth aspect there is presented a node device for associating the node device with a network domain. The node device comprises a processing unit. The processing unit is configured to cause the node device to receive a nonce challenge and a public key of a node manager being broadcasted by the node manager. The processing unit is configured to cause the node device to sign the nonce challenge and the public key of the node manager using a private key of the node device. The processing unit is configured to cause the node device to send, to the node manager, the signed nonce challenge and public key of the node manager.

According to a sixth aspect there is presented a computer program for associating a node device with a network domain, the computer program comprising computer program code which, when run on a processing unit of a node device, causes the node device to perform a method according to the fourth aspect.

According to a seventh aspect there is presented a computer program product comprising a computer program according to at least one of the third aspect and the sixth aspect and a computer readable means on which the computer program is stored.

It is to be noted that any feature of the first, second, third, fourth, fifth, sixth and seventh aspects may be applied to any other aspect, wherever appropriate. Likewise, any advantage of the first aspect may equally apply to the second, third, fourth, fifth, sixth, and/or seventh aspect, respectively, and vice versa. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communications network according to embodiments;

FIG. 2a is a schematic diagram showing functional units of a node manager according to an embodiment;

FIG. 2b is a schematic diagram showing functional modules of a node manager according to an embodiment;

FIG. 3a is a schematic diagram showing functional units of a node device according to an embodiment;

FIG. 3b is a schematic diagram showing functional modules of a node device according to an embodiment;

FIG. 4 shows one example of a computer program product comprising computer readable means according to an embodiment;

FIGS. 5, 6, 7, 8, and 9 are flowcharts of methods according to embodiments; and

FIGS. 10, 11, and 12 are signalling diagrams according to embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

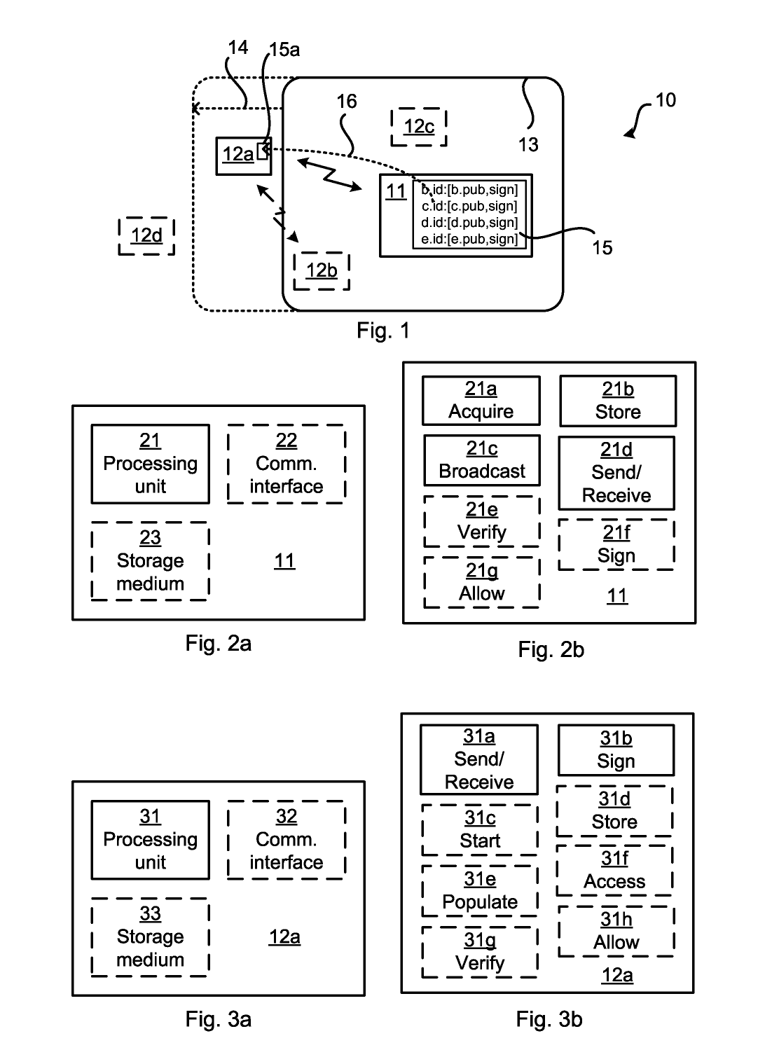

FIG. 1 is a schematic diagram illustrating a network 10 where embodiments presented herein can be applied. The network 10 comprises a node manager 11 and node devices 12a, 12b, 12c, 12d. The node manager 11 is the node manager of a network domain 13. Hence, according to the illustrative example of FIG. 1, the node devices 12b and 12c are initially within the network domain 13 whilst the node devices 12a and 12d are initially outside the network domain 13. It is for illustrative purposes assumed that the node device 12a is to join the network domain 13, thus causing the network domain 13 to expand, as indicated by the dotted arrow 14, such that the network domain 13 also encompasses node device 12a as indicated by the dotted lines. The network domain 13 may be defined as a group of node devices sharing the same perception of authority. The network domain 13 may thus be regarded as an administrative domain for the group of node devices.

There are different types of networks 10 in which the inventive concept may apply. For example, the network 10 may be a wireless network. However, the network 10 may alternatively be a wireline network.

The node devices 12a, 12b, 12c, 12d may be Bluetooth low energy devices, sensor devices, Internet-of-Things devices, smart home devices (such as security devices, kitchen appliances, temperature devices, heating, ventilating, and/or air conditioning devices, lighting devices), smart TVs, or any combination thereof, etc.

The node manager 11 may be a wireless device, such as a portable wireless device (mobile station, mobile phone, handset, wireless local loop phone, user equipment (UE), smartphone, laptop computer, tablet computer, etc.), but can also be a fixed wireless device such as a radio access network node (radio base station; base transceiver station; node B, evolved node B, etc.).

Each node device 12b, 12c should be able to securely communicate with another node device 12b, 12c within the network domain 13, and another node device 12a should, upon verification, be able to join the network domain 13.

As noted above, existing Public Key Infrastructure based mechanisms are centralized and for this reason less resilient to network attacks and disconnection from other networks.

According to at least some of the herein disclosed embodiments, currently known attacks are mitigated through a cryptographically verified public key distribution functionality.

According to at least some of the herein disclosed embodiments public keys as stored in distributed hash table 15s are signed by a manager key that has been distributed to node devices 12b, 12c within the network domain 13 and to node devices 12a which have joined the network domain. As will be further disclosed below, such a manager key can be used to verify each entry in the distributed hash table 15.

To create a resilient public key management system the task of key management is spread. A distributed hash table 15 may be used in order to distribute the task of key management to as many node devices as possible in the network 10. The public key of each node device in the network domain 13 can be signed by a root certificate to attest its authenticity in the given network domain 13. A key field (first field) may in the distributed hash table 15 be used to store the node identity, and a value field (second field) may in the distributed hash table 15 be used to store the signed public key of the node device. As will be further disclosed below, the distributed hash table 15 may be distributed redundantly to all node devices within the network domain 13 and be updated when a node device performs a GetPeer request for a node device in its local distributed hash table 15a.

The embodiments disclosed herein thus relate to associating a node device 12a with a network domain. In order to obtain such association of a node device 12a there is provided a node manager 11, a method performed by the node manager 11, a computer program comprising code, for example in the form of a computer program product, that when run on a processing unit of the node manager 11, causes the node manager 11 to perform the method. In order to obtain such association of a node device 12a there is further provided a node device 12a, a method performed by the node device 12a, and a computer program comprising code, for example in the form of a computer program product, that when run on a processing unit of the node device 12a, causes the node device 12a to perform the method.

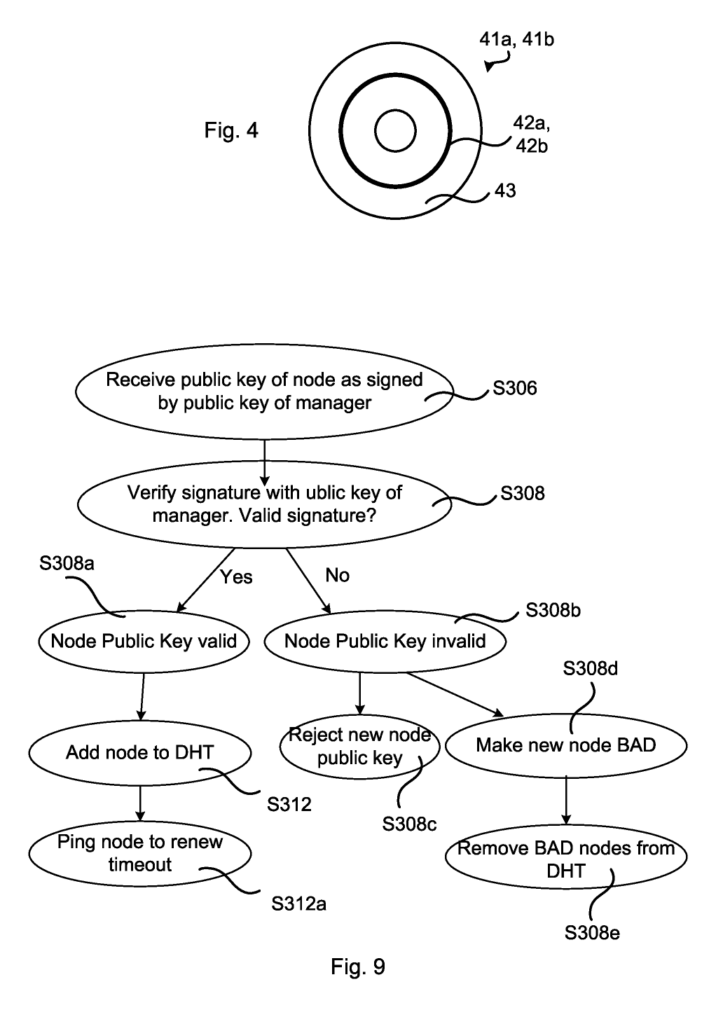

FIG. 2a schematically illustrates, in terms of a number of functional units, the components of a node manager 11 according to an embodiment. A processing unit 21 is provided using any combination of one or more of a suitable central processing unit (CPU), multiprocessor, microcontroller, digital signal processor (DSP), application specific integrated circuit (ASIC), field programmable gate arrays (FPGA) etc., capable of executing software instructions stored in a computer program product 41a (as in FIG. 4), e.g. in the form of a storage medium 23. Thus the processing unit 21 is thereby arranged to execute methods as herein disclosed. The storage medium 23 may also comprise persistent storage, which, for example, can be any single one or combination of magnetic memory, optical memory, solid state memory or even remotely mounted memory. The node manager 11 may further comprise a communications interface 22 for communications with at least one node device 12a, 12b, 12c, 12d. As such the communications interface 22 may comprise one or more transmitters and receivers, comprising analogue and digital components and a suitable number of antennas for wireless communications and ports for wireline communications. The processing unit 21 controls the general operation of the node manager 11 e.g. by sending data and control signals to the communications interface 22 and the storage medium 23, by receiving data and reports from the communications interface 22, and by retrieving data and instructions from the storage medium 23. Other components, as well as the related functionality, of the node manager 11 are omitted in order not to obscure the concepts presented herein.

FIG. 2b schematically illustrates, in terms of a number of functional modules, the components of a node manager 11 according to an embodiment. The node manager 11 of FIG. 2b comprises a number of functional modules; an acquire module 21a configured to perform below step S102, a store module 21b configured to perform below steps S104, S116, and a send and/or receive module 21d configured to perform below steps S106, S118, S122. The node manager 11 of FIG. 2b may further comprises a number of optional functional modules, such as any of a verify module 21e configured to perform below steps S110, S112, S114, S124, a sign module 21f configured to perform below step S120, and an allow module 21g configured to perform below step S126. The functionality of each functional module 21a-g will be further disclosed below in the context of which the functional modules 21a-g may be used. In general terms, each functional module 21a-g may be implemented in hardware or in software. Preferably, one or more or all functional modules 21a-g may be implemented by the processing unit 21, possibly in cooperation with functional units 22 and/or 23. The processing unit 21 may thus be arranged to from the storage medium 23 fetch instructions as provided by a functional module 21a-g and to execute these instructions, thereby performing any steps as will be disclosed hereinafter.

FIG. 3a schematically illustrates, in terms of a number of functional units, the components of a node device 12a according to an embodiment. A processing unit 31 is provided using any combination of one or more of a suitable central processing unit (CPU), multiprocessor, microcontroller, digital signal processor (DSP), application specific integrated circuit (ASIC), field programmable gate arrays (FPGA) etc., capable of executing software instructions stored in a computer program product 41b (as in FIG. 4), e.g. in the form of a storage medium 33. Thus the processing unit 31 is thereby arranged to execute methods as herein disclosed. The storage medium 33 may also comprise persistent storage, which, for example, can be any single one or combination of magnetic memory, optical memory, solid state memory or even remotely mounted memory. The node device 12a may further comprise a communications interface 32 for communications with a node manager 11 and, optionally, with at least one other node device 12b, 12c, 12d. As such the communications interface 32 may comprise one or more transmitters and receivers, comprising analogue and digital components and a suitable number of antennas for wireless communications and ports for wireline communications. The processing unit 31 controls the general operation of the node device 12a e.g. by sending data and control signals to the communications interface 32 and the storage medium 33, by receiving data and reports from the communications interface 32, and by retrieving data and instructions from the storage medium 33. Other components, as well as the related functionality, of the node device 12a are omitted in order not to obscure the concepts presented herein.

FIG. 3b schematically illustrates, in terms of a number of functional modules, the components of a node device 12a according to an embodiment. The node device 12a of FIG. 3b comprises a number of functional modules; a send and/or receive module 31a configured to perform below steps S204, S208, S210, S216, S218, S226, S228, and a sign module 31b configured to perform below step S206. The node device 12a of FIG. 3b may further comprises a number of optional functional modules, such as any of a start module 31c configured to perform below step S212, a store module 31d configured to perform below step S214, a populate module 31e configured to perform below step S220, an access module 31f configured to perform below step S222, a verify module 31g configured to perform below step S224, and an allow module 31h configured to perform below step S230. The functionality of each functional module 31a-h will be further disclosed below in the context of which the functional modules 31a-h may be used. In general terms, each functional module 31a-h may be implemented in hardware or in software. Preferably, one or more or all functional modules 31a-h may be implemented by the processing unit 31, possibly in cooperation with functional units 32 and/or 33. The processing unit 31 may thus be arranged to from the storage medium 33 fetch instructions as provided by a functional module 31a-h and to execute these instructions, thereby performing any steps as will be disclosed hereinafter.

FIG. 4 shows one example of a computer program product 41a, 41b comprising computer readable means 43. On this computer readable means 43, a computer program 42a can be stored, which computer program 42a can cause the processing unit 21 and thereto operatively coupled entities and devices, such as the communications interface 22 and the storage medium 23, to execute methods according to embodiments described herein. The computer program 42a and/or computer program product 41a may thus provide means for performing any steps of the node manager 11 as herein disclosed. On this computer readable means 43, a computer program 42b can be stored, which computer program 42b can cause the processing unit 31 and thereto operatively coupled entities and devices, such as the communications interface 32 and the storage medium 33, to execute methods according to embodiments described herein. The computer program 42b and/or computer program product 41b may thus provide means for performing any steps of the node device 12a as herein disclosed.

In the example of FIG. 4, the computer program product 41a, 41b is illustrated as an optical disc, such as a CD (compact disc) or a DVD (digital versatile disc) or a Blu-Ray disc. The computer program product 41a, 41b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 42a, 42b is here schematically shown as a track on the depicted optical disk, the computer program 42a, 42b can be stored in any way which is suitable for the computer program product 41a, 41b.

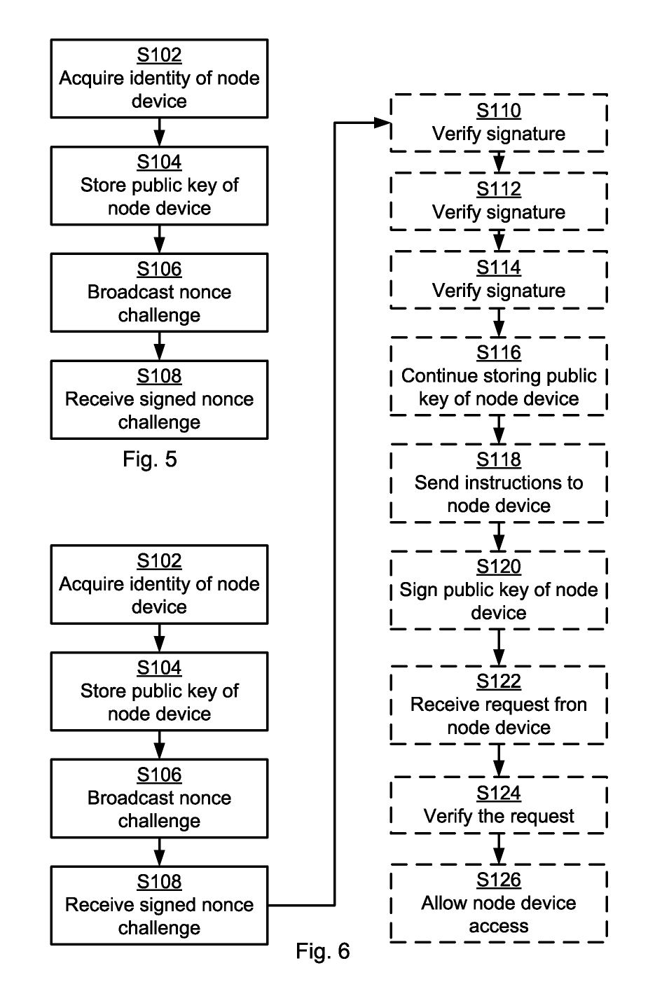

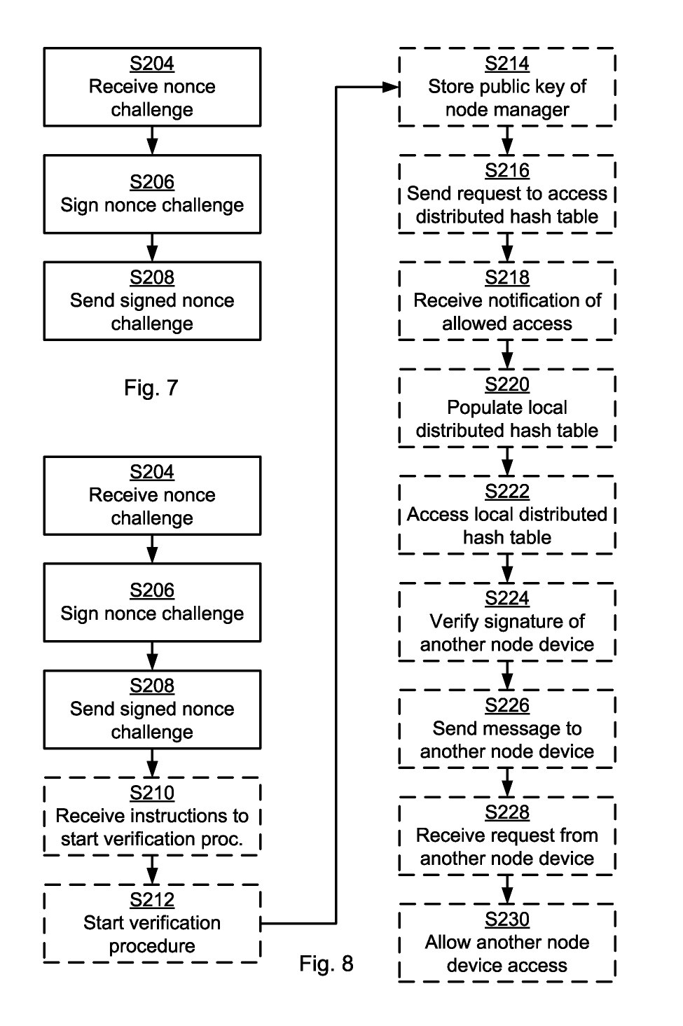

FIGS. 5 and 6 are flow charts illustrating embodiments of methods for associating a node device 12a with a network domain 13 as performed by the node manager 11. FIGS. 7 and 8 are flow charts illustrating embodiments of methods for associating a node device 12a with a network domain 13 as performed by the node device 12a. The methods are advantageously provided as computer programs 42a, 42b.

Reference is now made to FIG. 5 illustrating a method for associating a node device 12a with a network domain 13 as performed by the node manager 11 according to an embodiment.

The node manager 11 is configured to, in a step S102, acquire an identity of a node device 12a. The identity is indicative of a public key of the node device 12a. Different examples of identities and how the identity may be acquired will be provided below.

The node manager 11 is further configured to, in a step S104, at least temporarily store the public key of the node device 12a. There may be different ways for the node manager 11 to determine how long to store the public key of the node device 12a. For example, the node manager 11 may store the public key of the node device 12a until an indication is provided whether storage of the public key of the node device 12a is to be continued or not. This will be further disclosed below. For example, the node manager 11 may store the public key of the node device 12a only during a predetermined time interval, the predetermined time interval starting when the public key of the node device 12a is acquired by the node manager 11.

The node manager 11 is configured to, in a step S106, broadcast a nonce challenge and a public key of the node manager 11. In general terms, a nonce may be an arbitrary number used only once in a cryptographic communication. The nonce may be a random number or a pseudo-random number. The nonce may be issued in an authentication protocol. The nonce may be used to ensure that old communications cannot be reused in replay attacks.

The node manager 11 is configured to, in a step S108, receive, from the node device 12a, the nonce challenge and the public key of the node manager 11. Both the nonce challenge and the public key have been signed by a private key of the node device 12a.

The node manager 11 may thereby add the new node 12a to the network 3o domain 13 by signing the public key of the node device 12a using the private key of the node manager 11. The node device 12a is thereby no longer outside the network domain 13 but instead within the network domain 13. As will be further disclosed below, the thus signed public key of the node device 12a may then be put in a distributed hash table 15.

Embodiments relating to further details of associating a node device 12a with a network domain 13 as performed by the node manager 11 will now be disclosed.

Reference is now made to FIG. 6 illustrating methods for associating a node device 12a with a network domain 13 as performed by the node manager 11 according to further embodiments.

As noted above, there may be different examples of identities and how the identity of the node device 12a may be acquired. Different embodiments relating thereto will now be described in turn. According to embodiments, the identity is provided as a Quick Response (QR) code, a barcode, or a personal identification number (PIN) code. Hence, the node manager 11 may acquire the identity of the node device 12a by reading a QR code, reading a barcode, or by receiving a PIN code. Hence, the node manager 11 may comprise a QR code reader, a barcode reader, or a PIN code reader. QR codes, barcodes and PIN codes are as such known in the art and further description thereof is therefore omitted.

The node manager 11 may further be configured to, in a step S110, verify the signature of the signed nonce challenge and the public key of the node manager 11. There may be different ways for the node manager 11 to perform the verification in step S110. Different embodiments relating thereto will now be described in turn. According to an embodiment the verifying in step S110 comprises the node manager 11 to in a step S112 verify that the signed nonce challenge and the public key of the node manager was transmitted in response to the nonce challenge. According to an embodiment the verifying in step S110 comprises the node manager 11 to in a step S114 verify that the signed nonce challenge and the public key of the node manager was signed by the public key of the node device 12a.

There may be different ways for the node manager 11 to act once the signed nonce challenge and the public key of the node manager has been verified. For example, the node manager 11 may be configured to, in a step S116, continue storing the public key of the node device 12. That is, according to an embodiment the public key of the node device 12a is no longer stored if the signed nonce challenge and the public key of the node manager cannot be verified.

The node manager 11 may further request the node device 12a to verify its trust to the node manager 11. The node manager 11 may therefore be configured to, in a step S118, send instructions to the node device 12a to start a verification sequence. The node manager 11 may encrypt and sign the instructions with the public key of the node device 12a before sending the instructions to the node device 12a. An embodiment of the verification sequence will be provided below with reference to methods performed by the node device 12a.

There may be different ways for the node manager 11 to sign the public key of the node device 12a. For example, the node manager 11 may be configured to, in a step S120, sign the public key of the node device 12a using a private key of the node manager 11.

There may be different ways to provide the private key of the node manager 11. For example, the private key of the node manager 11 may have been encrypted by the node manager 11. There may be different ways to encrypt the private key of the node manager 11. For example, symmetric encryption may be used for encrypting the private key of the node manager 11.

There may be different ways for the node manager 11 to store the public key of the node device 12a. According to an embodiment the public key of the node device 12a is stored together with its signature in a distributed hash table 15. The distributed hash table 15 may comprise public keys and signatures of a plurality of node devices 12a, 12b, 12c.

There may be different ways for the node manager 11 to act once the public key of the node device 12a has been stored in the distributed hash table 15. Different embodiments relating thereto will now be described in turn. For example, the node manager 11 may be configured to, in a step S122, receive a request from the node device 12a to access the distributed hash table 15 so as to populate a local distributed hash table 15a (as indicated by the dotted arrow 16 in FIG. 1). The request is encrypted by the public key of the node manager 11. The node manager 11 may, in a step S124, verify the request. The node manager 11 may, in response thereto, in a step S126, allow the node device 12a access to the distributed hash table 15.

Reference is now made to FIG. 7 illustrating a method for associating a node device 12a with a network domain 13 as performed by the node device 12a according to an embodiment.

As noted above the node manager 11 may broadcast a nonce challenge and a public key of the node manager 11. This broadcast may be received by the node device 12a. The node device 12a is therefore configured to, in a step S204, receive a nonce challenge and a public key of a node manager being broadcasted by the node manager 11.

The nonce challenge and the public key of the node manager is signed by the node device 12a. Particularly, the node device 12a is configured to, in a step S206, sign the nonce challenge and the public key of the node manager 11 using a private key of the node device 12a.

Once the nonce challenge and the public key of the node manager have been signed, it is returned to the node manager 11. Thus, the node device 12a is configured to, in a step S208, send, to the node manager 11, the signed nonce challenge and public key of the node manager.

The node device 12a is thereby no longer outside the network domain 13 but instead within the network domain 13.

Embodiments relating to further details of associating a node device 12a with a network domain 13 as performed by the node device 12a will now be disclosed.

Reference is now made to FIG. 8 illustrating methods for associating a node device 12a with a network domain 13 as performed by the node device 12a according to further embodiments.

There may be different ways for the node device 12a to trigger reception of the nonce challenge and the public key. For example, the node device 12a may be configured to, in a step S202, send an identity of the node device 12a to the node manager 11. The nonce challenge and the public key may then be received in response to sending the identity to the node manager 11.

As disclosed above, the identity may be provided as a QR code, a barcode, or a PIN code. Hence, the node device 12a may be provided with, or associated with, a QR code, a barcode, or a PIN code. For example, a package of the node device 12a may have a QR code, a barcode, or a PIN code.

As noted above, the node manager 11 may request the node device 12a to start a verification sequence. Hence, according to an embodiment the node device 12a is configured to, in a step S210, receive instructions from the node manager to start a verification sequence. The node device 12a may then be configured to, in a step S212, start the verification sequence in response to having received the instructions.

There may be different ways for the node device 12a to perform the verification sequence. The verify sequence may differ depending on the device type In general terms, the verification sequence may not involve the node device 12a to send any data to the node manager 11. For example, the verification sequence may involve the node device 12a to emit output through a user interface. For example, the verification sequence may involve the node device 12a to output a sound and/or a visual indication. The sound and/or visual indication may be output according to a pattern. The pattern may be described by the verify sequence instructions.

The node device 12a may further be configured to, in a step S214, store the public key of the node manager 11.

The node device 12a may have a need to communicate with other node devices 12b, 12c in the network domain 13. The node device 12a may therefore be configured to, in a step S216, send a request to the node manager 11 to access a distributed hash table 15 so as to populate a local distributed hash table 15a. The request is encrypted by the public key of the node manager 11. As noted above, the distributed hash table 15 comprises public keys and signatures of a plurality of node devices 12a, 12b, 12c.

As noted above, the node manager 11 may allow the node device 12a to access the distributed hash table 15 only if the request can be verified. Hence, the node device 12a may be configured to, in a step S218, receive a notification of allowed access to the distributed hash table 15 from the node manager 11.

There may be different ways for the node device 12a to use the distributed hash table 15. Different embodiments relating thereto will now be described in turn.

For example, the node device 12a may use the distributed hash table 15 to find other node devices 12b, 12c within in the network domain 13. For example, the node device 12a may be configured to, in a step S220, populate the local distributed hash table 15a by accessing the distributed hash table 15 of the node manager 11 in response to having received the notification. That is, entries of the distributed hash table 15 of the node manager 11 may be copied to the distributed hash table 15 of the node device 12a so as to populate the distributed hash table 15 of the node device 12a.

For example, the node device 12a may use the distributed hash table 15 to acquire a public key of another node device 12b, 12c within in the network domain 13. That is, the node device 12a may be configured to, in a step S222, access the local distributed hash table 15a to acquire a public key of one node device 12b, 12c of the plurality of node devices 12b, 12c.

The node device 12a may then set up a secure communication with the other node device 12b within in the network domain 13. That is, the node device 12a may be configured to, in a step S224, verify a signature of the other node device 12b using the public key of the node manager 11; and, in a step S226, send a message to the other node device 12b. A signature from node device 12d would not be verified since node device 12d is outside the network domain 13. The message is encrypted using the public key of the other node device 12b and signed by the private key of the node device 12a. That is, the node device 12a may, by using the public key of the node manager 11, verify that the node manager 11 has signed the pubic key of the other node device 12b. The node device 12a may then generate a message addressed to the other node device 12b. The node device 12a may encrypt the message payload using the thus verified public key of the other node device 12b. The node device 12a may sign the entire message (including addressee) using its own private key and then send the message.

For example, the node device 12a may distribute the distributed hash table 15 to another node device 12b, 12c within in the network domain 13. That is, the node device 12a may be configured to, in a step S228, receive a request from another node device 12b, 12c to access the local distributed hash table 15a. The node device 12a may be configured to, in a step S230, allow, the another node device 12b, 12c access to the local distributed hash table 15a only if an identity of the another node device 12b, 12c is encrypted by the public key of the node manager 11 and the public key of the another node device 12b, 12c is provided in the distributed hash table 15. That is, a node device 12a, 12b, 12c within the network domain 13 will only reply to distributed hash table 15 queries if the node identity and public key of the node device querying access to the distributed has table has been signed by the public key of the node manager 11 and stored in its local distributed hash table 15a. Thus, if a node identity is missing in a given local distributed hash table 15a when this node device (say, node 12b) makes a query, the node device being queried (say, node 12a) will query an already trusted node device (say, node device 12c) for the identity and signed public key of the querying node device (node device 12b). Once this signed public key is retrieved by the node device being queried, the querying node device can be verified and its distributed hash table 15 queries will be responded to.

The node device 12a can thereby verify every transaction from another node device 12b, 12c using the signatures assigned to each message. The signatures are generated from a private node key that has a corresponding public node key. The public node keys are known by the hosts in the distributed hash table 15 and can be verified using the manager public key signature attached.

One particular embodiment for associating a node device 12a with a network domain 13 based on at least some of the above disclosed embodiments will now be disclosed in detail.

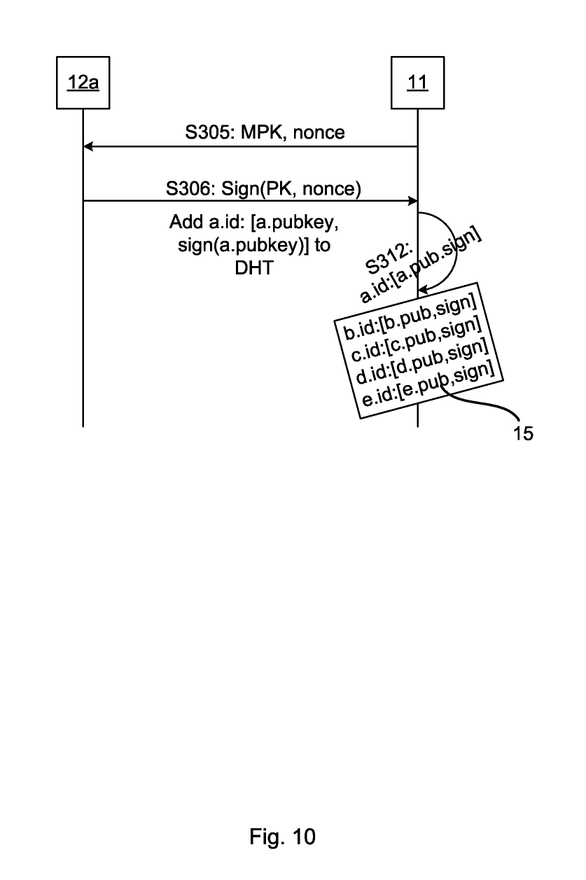

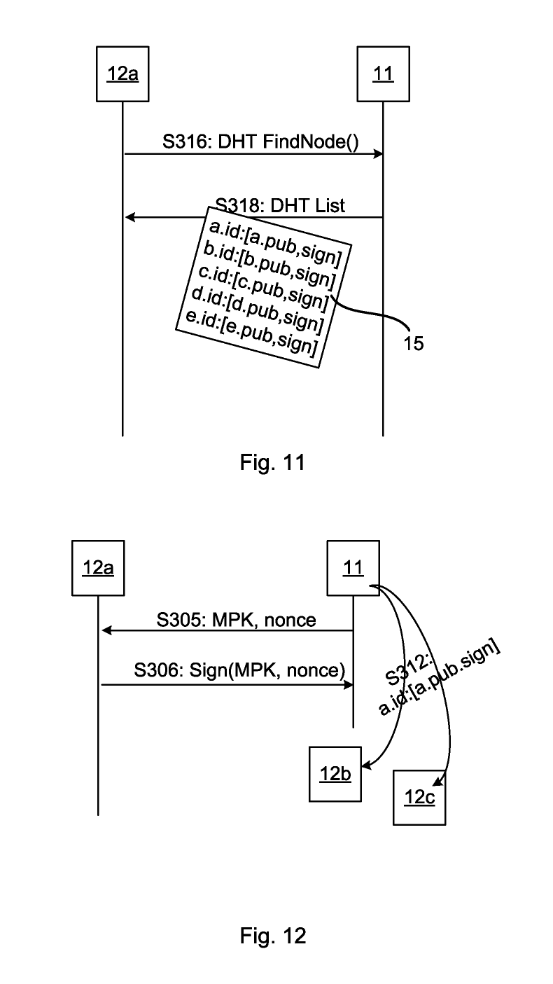

Parallel references are made to the flow chart of FIG. 9 and the signalling diagrams of FIGS. 10, 11, and 12.

The node manager 11 creates a new network domain 13 by performing steps S301 and S302.

S301. The node manager 11 generates a public and private key pair.

S302. Symmetric encryption is used to encrypt the private key.

For a new node device 12a to be associated with a network domain steps S303 and S304 are performed. Each new node device 12a is assumed to be associated with an identity, such as a QR code. The identity is indicative of a personal public key of the new node device 12a.

S303. The node manager 11 acquires the identity, and thus the public key of the new node device 12a, of the new node device 12a by scanning the QR code.

S304. The node manager 11 at least temporary stores the public key of the new node device 12a.

When the new node device 12a is powered on steps S305 to S311 are performed.

S305. The node manager 11 broadcasts a nonce challenge and its public key (Manager Public Key; MPK).

S306. The new node device 12a receives the nonce and the public key of the node manager 11 and signs the nonce and the public key with its own private key before sending it to the node manager 11. The signed public key and nonce is thus received by the node manager 11.

S308. The node manager 11 verifies the received signed public key and nonce to verify that it was a response to the same request (i.e., not replayed) and to verify that the signature was written by the associated public key as given by the identity of the new node device 12a acquired in step S303.

S308a. The verification is successful and thus the public key of the new node device 12a as given by the identity of the new node device 12a is determined valid.

S308b. The verification fails and thus the public key of the new node device 12a as given by the identity of the new node device 12a is determined invalid.

S308c. If the verification fails the public key of the new node device 12a is rejected.

S308d. If the verification fails the new node device 12a is considered bad and is not to join the network domain 13.

S308e. If the verification fails the new node device 12a is determined to either be faulty (from purchase) or not being associated with the intended network domain 13. S309. The node manager 11 continues to store the public key of the new node device 12a (together with identity information of the new node device 12a).

S310. Optionally, the node manager instructs the new node device 12a to verify its trust.

S311. The node manager 11 signs the public key of the new node device 12a using its own private key.

The manager node 11 has thereby completed its task of associating the new device 12a with the network domain 13.

The node manager 11 can now distribute public keys of other node devices 12b, 12c to the new node device 12a by performing step S312.

S312. The node manager 11 puts the public key of the new node device 12a together with its signature in a distributed hash table 15. The distributed hash table 15 comprises public keys and signatures of a plurality of node devices 12b, 12c.

S312a. The node manager 11 may ping the node device 12a to renew a timeout. A ping query and response thereto resets the timeout counter that determines availability of a node device. If a timeout is reached with no ping responses from the node device, the functionality of the node device is considered questionable and may later be removed from the distributed hash table (as in any of steps S308b, S308c, S308d, S308e). Similarly, the node device 12a stores the public key of the node manager 11 as in step S314.

S314. The node device 12 stores the public key of the node manager 11.

Other node devices 12b, 12c may request access to the distributed hash table 15 from the node manager 11 and the node manager 11 will respond with the new entry in the distributed hash table 15, i.e., the identity and signed public key of the new node device 12a. If the new node device 12a requests access to the distributed hash table 15 the node manager 11 will respond with the entire distributed hash table 15 so that the new node device 12a can populate a local distributed hash table 15a (i.e., a distributed hash table 15 of its own), as in steps S316 to S320.

S316: The new node device 12a requests access to the distributed hash table 15 to populate its own local distributed hash table 15a based on the public key of the node manager 11 and using either an encrypted or non-encrypted channel.

S318. Upon verification the node manager 11 allows the new node device 12a to access the distributed hash table 15.

S320. The new node device 12a searches its local distributed hash table 15a to find other node devices 12b, 12c, for example using a command FindNode.

S322. The new node device 12a searches its local distributed hash table 15a to acquire knowledge of the public keys of other node devices 12b, 12c in the network domain 13 in order to establish secure channels or verify message authenticity.

When properly set up, the node manager 11 is no longer needed for the node devices 12a, 12b, 12c to detect and verify each other. Hence, node device 12a can establish a secure cryptographic communication channel with any other node device 12b, 12c in the same network domain 13. A node device 12a, 12b, 12c can also distribute the public keys of any other node device 12a, 12b, 12c securely to any other verified node device 12a, 12b, 12c in the network domain 13. But only when the node manager 11 is available in the network domain 13 can a new node device join the network domain through the association procedure. This protects the network domain 13 from information leakage. More than one public and/or private key of the node manager 11 can be used in one network domain.

In summary, there has been presented mechanisms for secure distributed key distribution based on sharing public keys and signing the public keys by the authority (i.e., the node manager 11) of the network domain 13. The distributed nature these signed public keys have ensures a strong bond between node devices 12a, 12b, 12c regardless if the signee (i.e., the node manager 11) is still available in the network 10 or not. The inventive concept has mainly been described above with reference to a few embodiments. However, as is readily appreciated by a person skilled in the art, other embodiments than the ones disclosed above are equally possible within the scope of the inventive concept, as defined by the appended patent claims.

1-33. (canceled)

34. A method for associating a node device with a network domain, the method being performed by a node manager, the method comprising:
acquiring an identity of a node device, wherein the identity is indicative of a public key of the node device;
at least temporarily storing the public key of the node device;
broadcasting a nonce challenge and a public key of the node manager; and
receiving, from the node device, the nonce challenge and the public key of the node manager, both of which being signed by a private key of the node device.

35. The method of claim 34, wherein the identity is provided as a Quick Response code, a barcode, or a personal identification number code.

36. The method of claim 34, further comprising verifying the signature of the signed nonce challenge and the public key of the node manager.

37. The method of claim 36, wherein said verifying comprises verifying that the signed nonce challenge and the public key of the node manager was transmitted in response to said nonce challenge.

38. The method of claim 36, wherein said verifying comprises verifying that the signed nonce challenge and the public key of the node manager was signed by the public key of the node device.

39. The method of claim 36, further comprising continuing storing the public key of the node device.

40. The method of claim 34, further comprising sending instructions to the node device to start a verification sequence.

41. The method of claim 34, further comprising signing the public key of the node device using a private key of the node manager.

42. The method of claim 41, wherein the private key of the node manager has been encrypted by the node manager.

43. The method of claim 42, wherein symmetric encryption is used for encrypting the private key of the node manager.

44. The method of claim 34, wherein the public key of the node device is stored together with its signature in a distributed hash table.

45. The method of claim 44, wherein the distributed hash table comprises public keys and signatures of a plurality of node devices.

46. The method of claim 44, further comprising receiving a request from the node device to access the distributed hash table so as to populate a local distributed hash table, wherein the request is encrypted by the public key of the node manager.

47. The method of claim 46, further comprising:
verifying the request; and,
in response thereto, allowing the node device access to the distributed hash table.

48. The method of claim 34, wherein the network is a wireless network.

49. The method of claim 34, wherein the node device is a Bluetooth low-energy device.

50. A method for associating a node device with a network domain, the method being performed by the node device, the method comprising:
receiving a nonce challenge and a public key of a node manager being broadcasted by the node manager;
signing the nonce challenge and the public key of the node manager using a private key of the node device; and
sending, to the node manager, the signed nonce challenge and public key of the node manager.

51. The method of claim 50, further comprising:
sending an identity of the node device to the node manager; and
wherein the nonce challenge and the public key are received in response thereto.

52. The method of claim 51, wherein the identity is provided as a Quick Response code, a barcode, or a personal identification number code.

53. The method of claim 50, further comprising:
receiving instructions from the node manager to start a verification sequence; and
starting the verification sequence in response thereto.

54. The method of claim 53, wherein the verification sequence involves the node device emitting output through a user interface.

55. The method of claim 50, further comprising storing the public key of the node manager.

56. The method of claim 50, further comprising sending a request to the node manager to access a distributed hash table so as to populate a local distributed hash table, wherein the request is encrypted by the public key of the node manager, and wherein the distributed hash table comprises public keys and signatures of a plurality of node devices.

57. The method of claim 56, further comprising receiving a notification of allowed access to the distributed hash table from the node manager.

58. The method of claim 57, further comprising populating said local distributed hash table by accessing the distributed hash table of the node manager in response to having received said notification.

59. The method of claim 58, further comprising accessing said local distributed hash table to acquire a public key of one node device of said plurality of node devices.

60. The method of claim 59, further comprising:
verifying a signature of said one node device using the public key of the node manager; and
sending a message to said one node device, wherein the message is encrypted using the public key of said one node device and signed by the private key of the node device.

61. The method of claim 58, further comprising:
receiving a request from another node device to access said local distributed hash table; and
allowing said another node device access to the local distributed hash table only if an identity of said another node device is encrypted by the public key of the node manager and the public key of said another node device is provided in the distributed hash table.

62. A node manager for associating a node device with a network domain, the node manager comprising a processing circuit, the processing circuit being configured to cause the node manager to:
acquire an identity of a node device, wherein the identity is indicative of a public key of the node device;
at least temporarily store the public key of the node device;
broadcast a nonce challenge and a public key of the node manager; and
receive, from the node device, the nonce challenge and the public key of the node manager, both of which being signed by a private key of the node device.

63. A node device for associating the node device with a network domain, the node device comprising a processing circuit, the processing circuit being configured to cause the node device to:
receive a nonce challenge and a public key of a node manager being broadcasted by the node manager;
sign the nonce challenge and the public key of the node manager using a private key of the node device; and
send, to the node manager, the signed nonce challenge and public key of the node manager.

64. A non-transitory computer-readable medium comprising, stored thereupon, a computer program for associating a node device with a network domain, the computer program comprising computer code that, when run on a processing circuit of a node manager, causes the node manager to:
acquire an identity of a node device, wherein the identity is indicative of a public key of the node device;
at least temporarily store the public key of the node device;
broadcast a nonce challenge and a public key of the node manager; and
receive, from the node device, the nonce challenge and the public key of the node manager, both of which being signed by a private key of the node device.

65. A non-transitory computer-readable medium comprising, stored thereupon, a computer program for associating a node device with a network domain, the computer program comprising computer code that, when run on a processing circuit of the node device, causes the node device to:
receive a nonce challenge and a public key of a node manager being broadcasted by the node manager;
sign the nonce challenge and the public key of the node manager using a private key of the node device; and
send, to the node manager, the signed nonce challenge and public key of the node manager.
